(19) United States
(12) Patent Application Publication
(10) Pub. No.: US 2026/0160301 A1
(43) Pub. Date: Jun. 11, 2026

(54) DEVICE FOR FORECASTING A PHYSICAL PARAMETER MEASURED BY A SENSORIZED ROLLING ELEMENT AND ASSOCIATED METHODS AND SYSTEM

(71) Applicant: AKTIEBOLAGET SKF, GOTEBORG (SE)

(72) Inventors: Stephan BAGGEROHR, Houten (NL); Andreas Clemens VAN DER HAM, Warnsveld (NL); Defeng LANG, Delft (NL)

(21) Appl. No.: 19/181,439

(22) Filed: Apr. 17, 2025

(30) Foreign Application Priority Data
Apr. 26, 2024 (DE) 102024203936.5

(51) Int. Cl. F16C 41/00; G06N 20/00

(52) U.S. Cl. CPC F16C 41/00; G06N 20/00; F16C 2233/00; F16C 2352/00; F16C 2360/31

(57) ABSTRACT

A method and device for forecasting at least one machine physical parameter measured by a sensorized rolling element in a bearing of an operating machine, the method including determining at least a set of machine operating conditions representative of the operation conditions of the machine while the machine is operating and implementing a conditional imputation model configured to forecast the machine physical parameter from the machine operating conditions. Also a method for training a conditional imputation model configured to forecast a machine physical parameter from a set of machine operating conditions.

### CROSS-REFERENCE

This application claims priority to German patent application no. 10 2024 203 936.5 filed on Apr. 26, 2024, the contents of which are fully incorporated herein by reference.

### TECHNOLOGICAL FIELD

The present disclosure is directed to forecasting time series values of a sensorized rolling element implemented in a rolling bearing of a machine.

### BACKGROUND

U.S. Pat. No. 10,371,206 discloses a sensorized rolling element that includes a measuring device. The sensorized roller is embedded in a bearing of a machine, and the measuring device includes sensors, for example a load sensor, an accelerometer and a gyroscope.

The measurements of the sensors are wirelessly transmitting to an external receiver and are used to determine for example a contact pressure in the bearing or the remaining life of the bearing to monitor the bearing.

It is also known to implement physical models to monitor the bearing from data of the machine, the simulation models outputting predictions of the measurements delivered by the sensorized roller to determine the contact pressures in the bearing or the remaining life of the bearing. The predictions are extremely accurate and easily interpretable. However, implementing physical models is time costly and may require large computing power.

Further, the physical models are also sensitive to the boundary conditions, making rapid changes to the testing conditions difficult.

### SUMMARY

It is therefore an aspect of the present disclosure to render more robust the prediction of measurements delivered by a sensorized rolling element in a machine and without needing important resources.

According to an aspect, a method for at least one machine physical parameter is proposed. The physical parameter is measured by a sensorized rolling element in a machine. The machine comprises a rolling bearing including a first ring, for example, a stationary ring, and a second ring, for example, a rotatable ring, that are configured to rotate concentrically relative to one another, and at least one row of rolling elements interposed between a first raceway of the first ring and a second raceway of the second ring, where at least one of the rolling elements is the sensorized rolling element.

The method includes determining at least a set of machine operating conditions representative of the operation conditions of the machine, and implementing a conditional imputation model configured to forecast the machine physical parameter from the machine operating conditions. The conditional imputation model provides a quantitative prediction of the physical parameter from the machine operating conditions. The conditional imputation model is a digital twin of the sensorized rolling element which may be used to predict physical parameters in a more cost-effective and efficient way than using physical models.

Preferably, the conditional imputation model comprises a conditional structured state space diffusion model. Advantageously, the machine physical parameter is a load applied to the sensorized rolling element or a temperature of the sensorized rolling element or a speed of the sensorized rolling element.

According to another aspect, a method for training a conditional imputation model configured to forecast a machine physical parameter from a set of machine operating conditions is disclosed.

The physical parameter is measured by a sensorized rolling element in a machine that comprises a rolling bearing including a first ring, for example, a stationary ring and second ring, for example, a rotatable ring configured to rotate concentrically relative to one another, and at least one row of rolling elements interposed between a first raceway of the first ring and a second raceway of the second ring, at least one of the rolling elements being the sensorized rolling element, and the operating condition parameter being representative of the operating condition of the machine while the machine is currently operating.

The method includes determining at least one training set comprising time series values of the machine physical parameter measured by the sensorized rolling element in the machine and time series values of the machine operation conditions associated with the time series values of the machine physical parameter, implementing the conditional imputation model to determine an output set of machine physical parameter time series values from the machine operation conditions time series values of the training set, comparing the machine physical parameter time series values of the training set and the output set, and tuning the conditional imputation model according to the result of the comparison to capture long-term dependencies in time series values and machine operation conditions time series values.

Preferably, the conditional imputation model comprises a conditional structured state space diffusion model. Advantageously, the conditional structured state space diffusion model comprises a neural network, and tuning the conditional imputation model comprises tuning weights of the neural network according to the result of the first comparison.

According to another aspect, a device for forecasting at least one machine physical parameter measured by a sensorized rolling element in a machine is disclosed. The machine comprises a rolling bearing including a first ring, for example, a stationary ring and second ring, for example, a rotatable ring configured to rotate concentrically relative to one another, and at least one row of rolling elements interposed between a first raceway of the first ring and a second raceway of the second ring, at least one of the rolling elements being the sensorized rolling element.

The device comprises first determining means configured to determine at least a set of machine operation conditions representative of the operating condition of the machine, a memory storing a conditional imputation model configured to forecast the machine physical parameter from the machine operating conditions, and implementing means configure to implement the conditional imputation model.

Advantageously, the device comprises second determining means configured to determine at least one training set comprising time series values of the machine physical parameter measured by the sensorized rolling element in the machine and time series values of the machine operating conditions time series values associated with the time series values of the machine physical parameter. The implementing means are further configured to implement the conditional imputation model to determine an output set of machine physical parameter time series values from the machine operation conditions time series values of the training set.

The device further includes comparing means configured to compare the machine physical parameter time series values of the training set and the output set, and tuning means configured to tune the conditional imputation model according to the result of the first comparison to capture long-term dependencies in time series values and machine operating conditions time series values.

According to another aspect, a system for forecasting at least a set of time series values of at least one physical parameter measured by a sensorized rolling element in a machine is provided.

The machine comprises a rolling bearing including a first ring, for example, a stationary ring and a second ring, for example, a rotatable ring configured to rotate concentrically relative to one another, and at least one row of rolling elements interposed between a first raceway of the first ring and a second raceway of the second ring, at least one of the rolling elements being the sensorized rolling element. The system includes a device as previously defined and the machine comprising the rolling bearing.

### BRIEF DESCRIPTION OF THE DRAWINGS

Other advantages and features of the invention will appear on examination of the detailed description of embodiments, in no way restrictive, and the appended drawings in which:

FIG. 1 is a schematic illustration of a machine according to the an embodiment of the present disclosure.

FIG. 2 is a side elevational view, partly in section, that schematically shows an example of a roller bearing according to an embodiment of the present disclosure.

FIG. 3 is a schematic perspective view of an example of a sensorized rolling element according to an embodiment of the disclosure.

FIG. 4 is a schematic illustration of a device for forecasting at least a set of time series values of at least one physical parameter according to an embodiment of the disclosure.

FIG. 5 is a schematic illustration of an example of a conventional conditional imputation model.

FIG. 6 is a graph schematically illustrating an example of a method for training the conditional imputation model according to an embodiment of the present disclosure.

FIG. 7 is a flow chart illustrating an example of a method for training the conditional imputation model according to an embodiment of the present disclosure.

### DETAILED DESCRIPTION

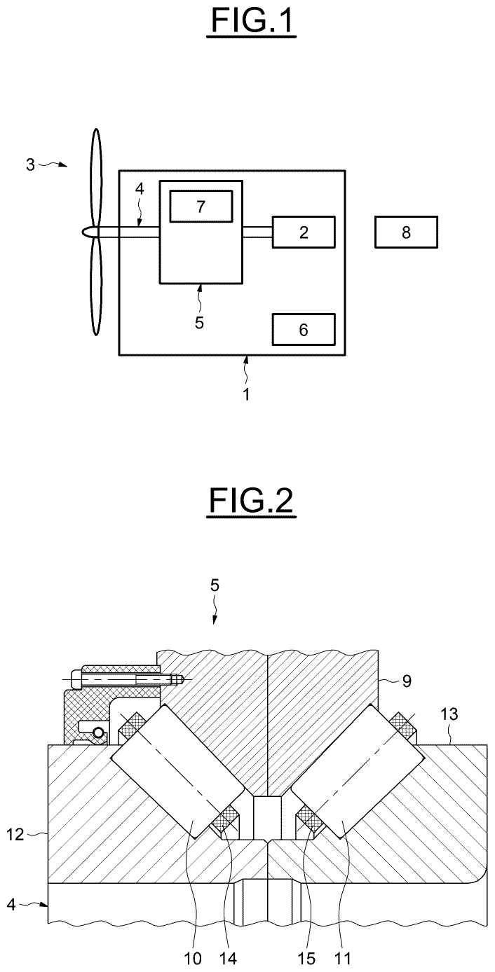

Reference is made to FIG. 1 which represents schematically an example of a machine 1 comprising a rolling bearing 5. The machine 1 may be a wind turbine comprising a generator 2, a propeller 3, a shaft 4 connecting a shaft of the generator 2 to the propeller 3, and a roller bearing 5 supporting the shaft 4. In other embodiments, the machine 1 may be a tunnel boring machine, a mining extraction machine or a big offshore crane.

The machine 1 may further comprise a sensor 6 to measure values of machine operating conditions representative of the operating condition of the machine 1. The machine operating conditions may be for example the wind speed, the speed of the shaft 4, the temperature of the machine or the power generated by the wind turbine 1. The machine operating conditions are measured while the machine is operating.

The roller bearing 5 comprises at least one sensorized rolling element 7. The sensorized rolling element 7 is configured to measure at least one machine physical parameter comprising for example a load applied on the sensorized rolling element 7 or a temperature of the sensorized rolling 7 element or a speed of the sensorized rolling element 7, and to deliver a set of time series values of the machine physical parameter.

In a non-represented variant, the wind turbine further comprises a gearbox connecting the shaft of the generator 2 to the shaft 4 of the wind turbine. A rolling bearing of the gearbox may comprise the sensorized rolling element 7. An example of the roller bearing 5 is detailed in the following.

The sensor 6 and the sensorized rolling element 7 communicate with a device 8 configured to forecast a set of time series values of the physical parameter measured by a sensorized rolling element 7. An example of the device 8 is detailed below. The machine 1 and the device 8 form a system for forecasting the machine physical parameter measured by the sensorized rolling element 7.

FIG. 2 illustrates schematically an example of the roller bearing 5. The bearing 5 comprises a first ring 9 (an outer ring or a stationary ring) provided with conically shaped first and second outer raceways for a first row 10 and a second row 11 of rolling elements comprising tapered rollers. The bearing further comprises a second ring (an inner or rotatable ring) formed from a first rotatable ring 12 and a second rotatable ring 13 axially adjacent to the first rotatable ring and which are respectively provided with conically shaped first and second inner raceways for the first and second roller rows 10, 11. In addition, the bearing 5 further comprises a first cage 14 and a second cage 15 for retaining the rollers of the first and second roller sets respectively. Typically, the cages may be formed from segments that abut each other in circumferential direction.

To provide the necessary stiffness and ensure a long service life, the bearing is preloaded. The axial position of the rotatable rings 12, 13 relatives to the stationary ring 9 is set such that the first and second roller sets 9, 11 have a preload (a negative internal clearance). In variant, the bearing is not preloaded.

In the depicted bearing, at least one of the rolling elements in either of the first and second roller rows 10, 11 is the sensorized rolling element 7. The shaft 4 is surrounded by and fixed to the rotatable rings 12, 13.

The rolling bearing 5 comprises tapered rollers. In another embodiment, the rolling bearing 5 may comprise other type of rolling elements, for example cylindrical rollers or spherical rollers. The rolling bearing 5 may also comprise only one row of rolling elements or more than two rows of rolling elements, the number of cages being determined based on the number of rows.

The rolling bearing 5 comprising a row of rolling elements comprises a unique inner ring. In another embodiment, the outer ring 9 is the rotatable ring and the inner rings 12, 13 are the stationary rings.

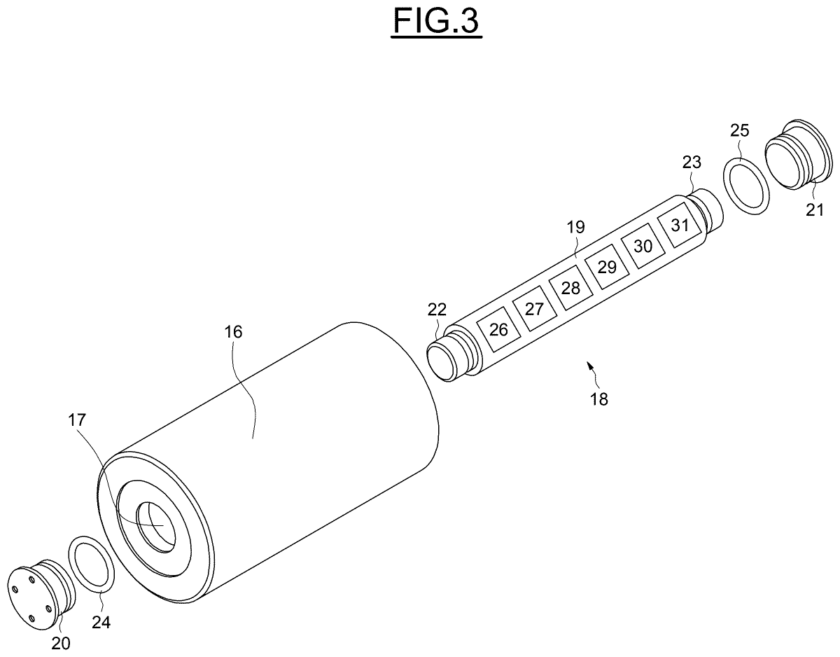

FIG. 3 illustrates schematically an example of the sensorized rolling element 7. The sensorized rolling element 7 comprises a roller body 16 comprising a central bore 17, and a sensor unit 18 mounted in the central bore 17 that extends through the roller body 16.

The sensor unit 18 comprises a housing 19 formed from two semi-cylindrical housings which are fixed together by first and second end caps 20, 21 that screw onto corresponding first and second threaded portions 22, 23 at opposite axial ends of the housing. The sensor unit housing 19 as a whole is shaped to fit within the roller bore 17 and is mounted to and located in the bore 17 by first and second sealing elements 24, 25. The sensor unit 18 is configured to measure the physical parameter and to deliver the set of time series values of the physical parameter.

The sensor unit 18 further comprises a load sensor 26 for measuring the load values applied on the sensorized rolling element 7. The sensor unit 18 may further comprise a speed sensor 27 for measuring the rotational speed of the sensorized rolling element 7 in the bearing 5 and may further comprise a temperature sensor 28 for measuring the temperature of the sensorized rolling element 7.

The sensor unit 18 comprises a wireless transmitter 29 for transmitting sets of measurements of the sensors 26, 27, 28, a sampler 30 to sample signals delivered by the sensors, and a battery 31 for powering the sensors 26, 27, 28 and the wireless transmitter.

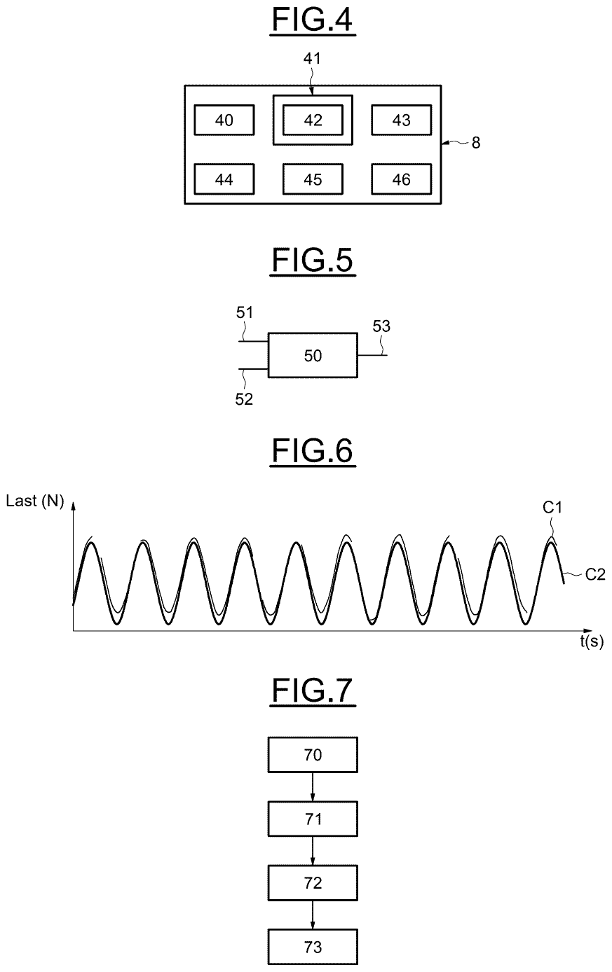

FIG. 4 illustrates schematically an example of the device 8. The device 8 comprises first determining means 40 configured to determine a set of machine operating conditions from values delivered by the sensor 6. The device 8 further comprises a memory 41 for storing a conditional imputation model 42, implementing means 43, comparing means 44, tuning means 45 and second determining means 46. The conditional imputation model 42 may comprise a conditional structured state space diffusion model including for example a neuronal network.

FIG. 5 illustrates schematically an example of the conditional imputation model 42 comprising a conditional structured state space diffusion model. The document entitled “Diffusion-based Time Series Imputation and Forecasting with Structured State Space Models,” by authors Juan Miguel Lopez Alcaraz and Nils Strodthoff, University of Oldenburg, Oldenburg, German discloses an example of conditional structured state space diffusion model and is hereby incorporated by reference.

Diffusion-based Time Series Imputation and Forecasting with Structured State Space Models is a method for handling missing input data in machine learning applications. The conditional structured state space diffusion model 50 comprises a neural network including 1D convolution layers and S4 layers. The conditional structured state space diffusion model 50 comprises a first input 51 configured to receive time series, a second input 52 configured to receive an imputation mask and an output 53.

Note that the conditional imputation model 42 is trained to minimize at least one cost function relating to, for example, mean square error, mean absolute error or binary cross entropy. The trained conditional imputation model 42 stored in the memory 41 and implemented by the implementing means 43, forecasts the machine physical parameter from a set of machine operating conditions from the first determining means 40.

Time series values of the set of machine operation conditions are inputted on the first input 51, the second input 52 is set to zero and the forecasted set of time series values of the machine physical parameter is delivered on the output 53.

FIG. 6 illustrates schematically an example of the set of time series values of the machine physical parameter forecasted by the trained conditional imputation model 42. The machine physical parameter comprises the load. A curve C1 represents the load measured by the sensorized rolling element 7 according to the time t and comprising missing values. A curve C2 represents the load forecasted by the trained conditional imputation model 42 from a set of time series values of the machine operating condition parameter associated with the load measured by the sensorized rolling element 7.

FIG. 7 illustrates an example of a method for training the conditional imputation model 42. In a step 70, the second determining means 46 determine at least one training set comprising time series values of the machine physical parameter measured by the sensorized rolling element 7 in the machine 1 and time series values of the machine operating conditions time series values associated with the time series values of the machine physical parameter.

In a step 71, the conditional imputation model 42 is trained from the training set or a plurality of training sets. For each training set, the implementing means 43 implement the conditional imputation model 42 to determine an output set of machine physical parameter time series values from the machine operating conditions time series values of the training set.

The machine operating conditions time series values of the training set are inputted on the first input 51 of the conditional structured state space diffusion model 50 and the second input 52 of the conditional structured state space diffusion model 50 is set to zero. In a step 71, for each training set, the comparing means 44 perform a first comparison between the output set of machine physical parameter time series values and the machine physical parameter time series values of the training set. The comparing means 44 may implement a mean absolute error algorithm.

The tuning means 45 tune the conditional imputation model 42 according to the result of the first comparison to capture long-term dependencies in time series values and machine operating conditions time series values. The tuning means 45 tune the conditional imputation model 42 according to the result of the first comparison to minimize a cost function related to for example mean absolute error.

When the conditional imputation model 42 is made of a neuronal network, the tuning means 45 tune weights of the neural network according to the result of the first comparison. The tuning means 45 tune weights of the neural network according to the result of the first comparison to minimize a cost function related to for example mean absolute error.

The method may further comprise validation steps 72, 73 of the trained conditional imputation model 42 to check that the accuracy of the time series values of the machine physical parameter determined by the conditional imputation model 42 is enough.

It is assumed that validation sets are obtained.

Each validation set comprises time series values of the machine physical parameter measured by the sensorized rolling element 7 in the machine 1 and machine operating conditions time series values associated with the time series values. The validation sets may be obtained by the second determining means 46.

In a step 72, for each validation step, the implementing means 43 implement the conditional imputation model 42 from the machine operating conditions time series values of the validation set to determine a second output set of time series values.

In a step 73, for each validation set, the comparing means 44 perform a second comparison between the second output set of machine physical parameter time series values and the machine physical parameter time series values of the validation set.

The tuning means 45 tune the conditional imputation model 42 according to the result of the second comparison to minimize the cost function.

The device 8 gives a quantitative prediction of the set of time series values of the physical parameter from the set of machine operating conditions time series values.

The conditional imputation model 42 is a digital twin of the sensorized rolling element 7.

The conditional imputation model 42 may be used to predict physical parameters in a more cost-effective and efficient way than using physical models. The conditional imputation model 42 may be used to identify potential problems and inefficiencies before they occur in the machine 1 to optimize the design and operation of the machine 1.

The conditional imputation model 42 may provide real-time data about the performance of the machine 1 to operate the machine 1 in a more efficient way.

The conditional imputation model 42 may be used as a virtual sensor in the event the sensorized rolling element looses its ability to collect data, for example when a battery suppling the sensorized rolling element 7 is depleted, or when the roller bearing 5 does not comprise a sensorized rolling element 7. The conditional imputation model 42 allows to simulate the operation of the machine 1 under different conditions, to identify potential failure points and take steps to prevent them from occurring on the machine 1 to improve the reliability of the machine 1.

The first and second determining means, the implementing means, the comparing means and the tuning means may each comprise one or more programmable hardware components such as a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor. One or more of each of the foregoing means may also be implemented on a same programmable hardware component.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved forecasting devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for forecasting at least one machine physical parameter measured by a sensorized rolling element in an operating machine, the machine comprising a rolling bearing including a stationary ring and a rotatable ring configured to rotate concentrically relative to one another and a plurality of rolling elements interposed between a first raceway of the stationary ring and a second raceway of the rotatable ring, at least one of the plurality of rolling elements being the sensorized rolling element, the method comprising:
determining at least a set of machine operating conditions representative of the operation conditions of the machine while the machine is operating, and
implementing a conditional imputation model configured to forecast the machine physical parameter from the machine operating conditions.

2. The method according to claim 1,
wherein the conditional imputation model comprises a conditional structured state space diffusion model.

3. The method according to claim 1,
wherein the machine physical parameter is a load applied to the sensorized rolling element or a temperature of the sensorized rolling element or a speed of the sensorized rolling element.

4. The method according to claim 3,
wherein the machine is a wind turbine, a tunnel boring machine, a mining extraction machine or a crane.

5. A method for training a conditional imputation model configured to forecast a machine physical parameter from a set of machine operating conditions, the machine physical parameter being measured by a sensorized rolling element in a machine while the machine is operating, the machine comprising a rolling bearing including a stationary ring and a rotatable ring configured to rotate concentrically relative to one another and a plurality of rolling elements interposed between a first raceway of the stationary ring a second raceway of the rotatable ring, at least one of the plurality of rolling elements being the sensorized rolling element, the operating condition parameter being representative of the operating condition of the machine, the method comprising:
determining at least one training set comprising time series values of the machine physical parameter measured by the sensorized rolling element in the machine while the machine is operating and time series values of the machine operating conditions associated with the time series values of the machine physical parameter,
implementing the conditional imputation model to determine an output set of machine physical parameter time series values from the machine operating conditions time series values of the training set,
comparing the machine physical parameter time series values of the training set and the output set, and
tuning the conditional imputation model according to a result of the comparing to capture long-term dependencies in time series values and machine operating conditions time series values.

6. The method according to claim 5,
wherein the conditional imputation model comprises a conditional structured state space diffusion model.

7. The method according to claim 6,
wherein the conditional structured state space diffusion model comprises a neural network, and
wherein tuning the conditional imputation model comprises tuning weights of the neural network according to the result of the first comparison.

8. The method according to claim 5,
wherein the machine physical parameter is a load applied to the sensorized rolling element or a temperature of the sensorized rolling element or a speed of the sensorized rolling element, and
wherein the machine is a wind turbine, a tunnel boring machine, a mining extraction machine or a crane.

9. A device for forecasting at least one machine physical parameter measured by a sensorized rolling element in an operating machine, the machine comprising a rolling bearing including a stationary ring and a rotatable ring configured to rotate concentrically relative to one another, and a plurality of rolling elements interposed between a first raceway of the stationary ring and a second raceway of the rotatable ring, at least one of the plurality of rolling elements being the sensorized rolling element, the device comprising:
first determining means configured to determine at least a set of machine operating conditions representative of the operating condition of the machine while the machine is operating,
a memory storing a conditional imputation model configured to forecast the machine physical parameter from the machine operating conditions, and
implementing means configure to implement the conditional imputation model.

10. The device according to claim 9, including:
second determining means configured to determine at least one training set comprising time series values of the machine physical parameter measured by the sensorized rolling element in the machine and time series values of the machine operating conditions time series values associated with the time series values of the machine physical parameter,
comparing means configured to compare the machine physical parameter time series values of the training set and the output set, and
tuning means configured to tune the conditional imputation model according to the result of the first comparison to capture long-term dependencies in time series values and machine operating conditions time series values,
wherein the implementing means are further configured to implement the conditional imputation model to determine an output set of machine physical parameter time series values from the machine operating time series values of the training set.

11. The device according to claim 9,
wherein the machine physical parameter is a load applied to the sensorized rolling element or a temperature of the sensorized rolling element or a speed of the sensorized rolling element, and
wherein the machine is a wind turbine, a tunnel boring machine, a mining extraction machine or a crane.

12. A system for forecasting at least a set of time series values of at least one physical parameter measured by a sensorized rolling element in an operating machine, the machine comprising a rolling bearing including a stationary ring and a rotatable ring configured to rotate concentrically relative to one another, and a plurality of rolling elements interposed between a first raceway of the stationary ring and a second raceway of the rotatable ring, at least one of the plurality of rolling elements being the sensorized rolling element, the system comprising:
a device according to claim 11, and
the machine comprising the rolling bearing.

13. A system for forecasting at least a set of time series values of at least one physical parameter measured by a sensorized rolling element in an operating machine, the machine comprising a rolling bearing including a stationary ring and a rotatable ring configured to rotate concentrically relative to one another, and a plurality of rolling elements interposed between a first raceway of the stationary ring and a second raceway of the rotatable ring, at least one of the plurality of rolling elements being the sensorized rolling element, the system comprising:
a device according to claim 9, and
the machine comprising the rolling bearing.
